(19) United States
(12) Patent Application Publication
(10) Pub. No.: US 2016/0376917 A1
(43) Pub. Date: Dec. 29, 2016

(54) METHOD AND AN APPARATUS FOR MEASURING A DEFLECTION OF A ROTOR OF A TURBOMACHINE

(71) Applicant: Siemens Energy, Inc., Orlando, FL (US)

(72) Inventor: Alejandro Bancalari, Casselberry, FL (US)

(21) Appl. No.: 14/753,240

(22) Filed: Jun. 29, 2015

(51) Int. Cl. F01D 21/00; F01D 5/12; F01D 5/02

(52) U.S. Cl. CPC F01D 21/003; F01D 5/02; F01D 5/12; F05D 2220/30; F05D 2260/80; F05D 2270/804; F05D 2270/808

(57) ABSTRACT

A method and an apparatus for measuring a deflection of a rotor of a turbomachine are presented. An optical fiber is inserted through a central bore of the rotor such that the optical fiber extends lengthwise through the bore along an axial direction of the rotor. The optical fiber is made up of a plurality of fiber optic strain sensors along the length of the optical fiber. A shape of the optical fiber is reconstructed based on strain information obtained from the plurality of the fiber optic strain sensors. A rotor deflection parameter is determined from the reconstructed shape of the optical fiber.

### FIELD

Aspects of the present invention relate to a method and an apparatus for measuring a deflection of a rotor of a turbomachine.

### DESCRIPTION OF RELATED ART

A turbomachine, such as a turbine or a compressor, includes rotating components mounted on a rotor shaft. For example, in a gas turbine, the rotating components include one or more rotor disks each carrying a row of rotating blades. The weight of the rotor shaft, along with that of the other rotating components, such as the rotor disks, may cause the rotor shaft to bend or sag or deflect in any other manner from its axis of rotation. For normal functioning of the turbomachine to be maintained, it is desirable to measure and rectify any deflection of the rotor shaft.

Current techniques for measuring a deflection of a rotor may include, for example using tip clearance probes. Such an approach may only allow deflection measurements of the rotor to be taken in certain locations. Furthermore, this approach may only allow deflection measurements when the turbomachine is offline. Currently, the issue is addressed by reducing the rotor deflection measurements only to outage where such measurements can be executed.

### SUMMARY

Briefly described, aspects of the present invention relate to a method and an apparatus for measuring a deflection of a rotor of a turbomachine engine.

According to an aspect, a method for measuring a deflection of a rotor of a turbomachine engine comprises inserting an optical fiber through a central bore of the rotor such that the optical fiber extends lengthwise through the bore along an axial direction of the rotor. The optical fiber is made up of a plurality of fiber optic strain sensors along the length of the optical fiber. Strain information of the optical fiber is measured from the plurality of the fiber optic strain sensors. A shape of the optical fiber is reconstructed based on the measured strain information. A rotor deflection parameter is determined from the reconstructed shape of the optical fiber.

According to another aspect, an apparatus for measuring a deflection of a rotor of a turbomachine engine comprises an optical fiber. The optical fiber is inserted through a central bore of the rotor such that the optical fiber extends lengthwise through the bore along an axial direction of the rotor. The optical fiber is made up of a plurality of fiber optic strain sensors along the length of the optical fiber. Strain information of the optical fiber is measured from the plurality of the fiber optic strain sensors. A shape of the optical fiber is reconstructed based on the measured strain information. A rotor deflection parameter is determined from the reconstructed shape of the optical fiber.

Various aspects and embodiments of the application as described above and hereinafter may not only be used in the combinations explicitly described, but also in other combinations. Modifications will occur to the skilled person upon reading and understanding of the description.

### BRIEF DESCRIPTION OF THE DRAWINGS

Exemplary embodiments of the application are explained in further detail with respect to the accompanying drawings. In the drawings:

FIG. 1 illustrates a longitudinal sectional view of a turbomachine according to an embodiment;

FIG. 2 is a diagrammatic illustration of an apparatus to be used for measuring a deflection of a rotor of a turbomachine according to an embodiment; and

FIG. 3 illustrates a longitudinal sectional view of a turbomachine with the inventive apparatus positioned therein.

To facilitate understanding, identical reference numerals have been used, where possible, to designate identical elements that are common to the figures.

### DETAILED DESCRIPTION OF INVENTION

A detailed description related to aspects of the present invention is described hereafter with respect to the accompanying figures.

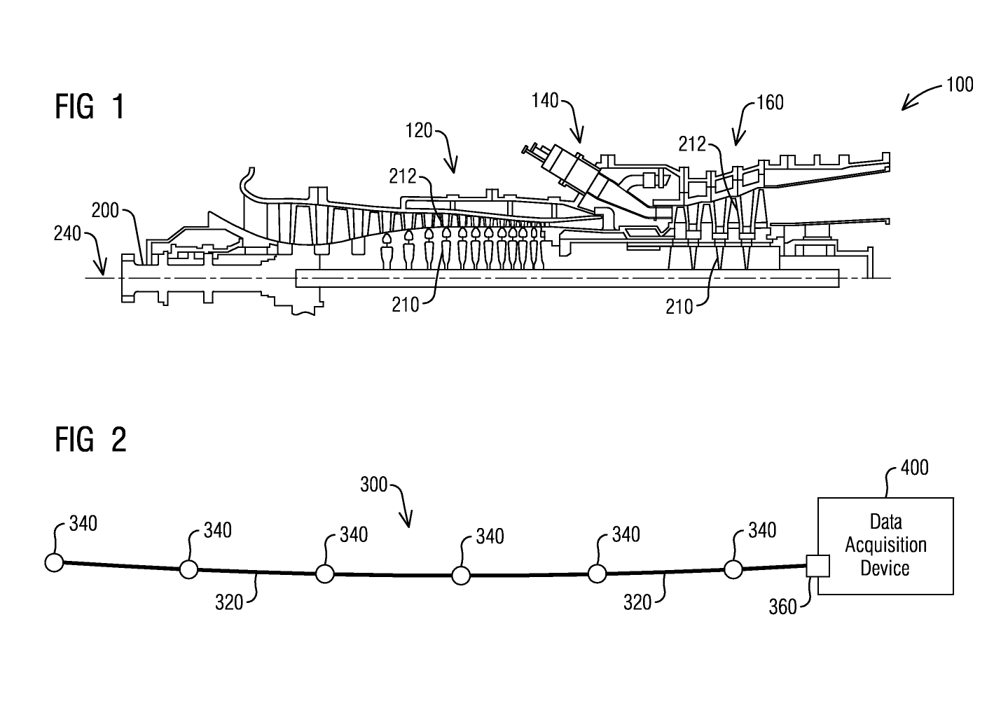

FIG. 1 illustrates a longitudinal sectional view of a turbomachine, which in this example is a gas turbine engine. According to the illustrated embodiment, the engine 100 comprises a compressor section 120, a combustion section 140, a turbine section 160. In the illustrated embodiment, the compressor section 140 and the turbine section 160 are mounted on a common rotor shaft 200, having a rotation axis 240. On the shaft 200 are mounted rotor disks 210, each carrying a row of rotating blades 212.

As illustrated in FIG. 1, during operation of the engine 100, the compressor section 120 may provide a compressed air flow to the combustion section 140. The compressed air in the combustion section 140 maybe mixed with a fuel and ignited to provide a hot gas. The hot gas expands through the turbine section 160 which causes the rotor 200 to rotate. After a period of operation of the engine 100, the rotor shaft 200 may deflect due to the weight of the rotor 200 as well as the rotating components.

FIG. 2 illustrates an apparatus 300 to be used for measuring a deflection of a rotor of a turbomachine according to an embodiment. As illustrated in FIG. 2, the apparatus 300 may comprises an optical fiber 320. The optical fiber 320 may comprise a plurality of fiber optic strain sensors 340 along a length of the optical fiber 320. For the sake of clarity, only six such strain sensors 340 are shown in FIG. 2. In practice, the optical fiber 320 may be made up of an array of a large number of discretely positioned strain sensing elements, for example, fiber optic strain sensors 340, arranged along the length of the optical fiber 320. The strain sensors 340 are configured to capture strain information of the optical fiber 320 at their respective positions along the length of the optical fiber 320. The strain information is fed to a data acquisition device 400, such as a computer.

Fiber optic strain sensors 340 are well established for applications in smart structures. Advantages of fiber optic strain sensors 340 may include their small size, low cost, multiplexing capabilities, and capability to be embedded into structures.

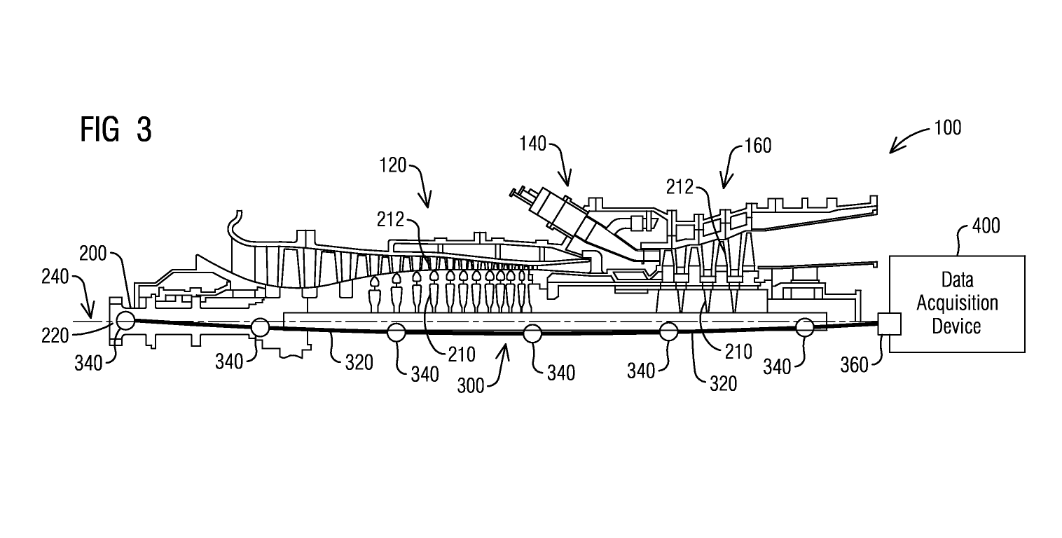

As shown in FIG. 3, to monitor a deflection of the rotor 200, the optical fiber 320 having the fiber optic strain sensors 340 is inserted centrally into the rotor 200 of the engine 100 through an axially extending bore 220 through the rotor 200. During operation or after a period of operation, the rotor 200 tends to deflect or deviate from its rotation axis 240, for example by way of sagging resulting in a change in the shape of the rotor 200. The optical fiber 320 undergoes a corresponding change in shape. Discrete strain information at various discrete points along the length of the optic fiber 320 may be measured by the fiber optic strain sensors 340 and relayed to the data acquisition device 400. The discrete strain information essentially indicates a change of position of the respective strain sensor 340 with respect to its natural state as measured from a fixed reference coordinate system. The natural state corresponds to an unbent and/or undetected configuration of the optical fiber 320 along the rotation axis 240 of the rotor 200. The data acquisition device 400 reconstructs a shape of the optical fiber 320 from the strain information from various positions on the optical fiber 320 as measured by the strain sensors 340. The shape of the optical fiber 320 generally corresponds to the shape of the rotor 200. Accordingly, a precise shape of the rotor 200 may be directly or indirectly derived from the reconstructed shape of the optical fiber 320, from which a deflection parameter may be calculated.

According to an embodiment, the shape of the optical fiber 320 may be represented by the various discrete points along the length of the optic fiber 320 to which fit a polynomial trend line. A deflection parameter of a rotor 200 may comprise a linearity of a rotor 200, a concavity of a rotor 200, a maximum deflection of a rotor 200 from a rotation axis 240, or any combinations thereof. A linearity of a rotor 200 may refer to how well the measured discrete strain information fits this polynomial trend line. A concavity of a rotor 200 may refer to whether the polynomial trend line is deflected up or down along the rotation axis 240, along with inflection points if the concavity changes along the rotation axis 240. A maximum deflection of a rotor 200 from a rotation axis 240 may refer to a maximum distance from the rotation axis 240 to a furthest point measured radially from the rotation axis 240.

When a deflection measurement is intended, for example, during an outage or engine standstill, the optical fiber 320 may be coupled to the data acquisition device 400 for data collection. At other times, for example, during engine operation, the optical fiber 320 may remain decoupled from the data acquisition device 400 while still being inserted in the rotor 200.

According an alternate embodiment, the optical fiber 320 may be coupled to the data acquisition device 400 via a fastener 360 with a free rotating joint, which allows rotation of the optical fiber 320 while still maintaining electrical contact with the data acquisition device 400 .This enables real-time monitoring of the shape of the rotor 200 during engine operation, by allowing the data acquisition device 400 to capture a time series of strain information from the array of strain sensors 340 and to use the time series to dynamically reconstruct the shape of the optical fiber 320, to obtain a shape of the rotor 200.

According to an embodiment, the size (i.e., a diameter) of the central bore 220 through the rotor 200 may be configured to provide a sufficiently tight tolerance with the optical fiber 320, to prevent or minimize any relative change in position of the optical fiber 320 with respect to the rotor 200, such as a twisting of the optical fiber 320 within the bore 220. This would ensure that the shape of the optical fiber 320 conforms at all times to the shape of the rotor 200 with a desired degree of accuracy.

According to an embodiment, a three dimensional shape of a rotor 200 may be determined from stain information of an optical fiber 320. According to an embodiment, a deflation of a rotor 200 may be determined from the three dimensional shape of the rotor 200.

According to an aspect, the illustrated embodiments may significantly reduce a time for determining a rotor deflection parameter of a rotor 200 in real time during an operation of the rotor 200.

The illustrated embodiments may provide high resolution measurements of a rotor deflection parameter of a rotor 200 during an operation of the rotor 200 based on strain information of an optical fiber 320 obtained from fiber optical strain sensors 340 along a length of the optical fiber 320. A typical but non-limiting exemplary resolution of a fiber optical strain sensing system is about 0.0005″. The illustrated embodiments may provide more than 1000 measurements in a half inch interval.

The illustrated embodiments may simplify a data collection with regards to a rotor 200 of an engine 100 in real time during an operation of the rotor 200.

The disclosed method and the apparatus may be implemented to a plurality of different types of rotating machines, for example, turbomachine including gas turbines, steam turbines, etc.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

### List of References

120 Compressor Section of an Engine
140 Combustion Section of an Engine
160 Turbine Section of an Engine
200 Rotor of an Engine
210 Rotor Disks
212 Rotating Blades
220 Central Bore of a Rotor
240 Rotation Axis
300 Rotor Deflection Measurement Apparatus
320 Optical Fiber
340 Fiber Optic Strain Sensors
360 Fastener
400 Data Acquisition Device

What is claimed is:

1. A method for measuring a deflection of a rotor of a turbomachine comprising:
inserting an optical fiber through a central bore of the rotor such that the optical fiber extends lengthwise through the bore along an axial direction of the rotor, wherein the optical fiber is made up of a plurality of fiber optic strain sensors along the length of the optical fiber;
measuring strain information of the optical fiber from the plurality of the fiber optic strain sensors;
reconstructing a shape of the optical fiber based on the measured strain information of the optical fiber; and
determining a rotor deflection parameter from the reconstructed shape of the optical fiber.

2. The method according to claim 1, wherein the optical fiber is coupled to a data acquisition device which reconstructs the shape of the optical fiber based on the measured strain information of the optical fiber.

3. The method according to claim 2, wherein the rotor deflection parameter is determined in a reference coordinate system with respect to the data acquisition device.

4. The method according to claim 1, wherein the rotor defection parameter is determined in real time during operation of the rotor based on instantaneous strain information obtained from the plurality of the fiber optic strain sensors.

5. The method according to claim 1, wherein the determined rotor deflection parameter comprises a linearity of the rotor.

6. The method according to claim 1, wherein the determined rotor deflection parameter comprises a concavity of the rotor.

7. The method according to claim 1, wherein the determined rotor deflection parameter comprises a maximum deflection of the rotor from a rotation axis.

8. The method according to claim 1, wherein the optic fiber is coupled to a data acquisition device using a free rotating joint.

9. The method according to claim 1, wherein a three dimensional shape of the rotor is determined based on the strain information, and wherein the rotor defection parameter is determined from the three dimensional shape of the rotor.

10. An apparatus for measuring a deflection of a rotor of a turbomachine comprising:
an optic fiber inserted through a central bore of the rotor such that the optical fiber extends lengthwise through the bore along an axial direction of the rotor,
wherein the optical fiber is made up of a plurality of fiber optic strain sensors along the length of the optical fiber,
wherein strain information of the optical fiber is measured from the fiber optic strain sensors,
wherein a shape of the optical fiber is reconstructed based on the measured strain information of the optical fiber, and
wherein a rotor deflection parameter is determined from the reconstructed shape of the optical fiber.

11. The apparatus according to claim 10, wherein the optical fiber is coupled to a data acquisition device which reconstructs the shape of the optical fiber based on the measured strain information of the optical fiber.

12. The apparatus according to claim 11, wherein the rotor deflection parameter is determined in a reference coordinate system with respect to the data acquisition device.

13. The apparatus according to claim 10, wherein the rotor defection parameter is determined in real time during operation of the rotor based on instantaneous strain information obtained from the plurality of the fiber optic strain sensors.

14. The apparatus according to claim 10, wherein the determined rotor deflection parameter comprises a linearity of the rotor.

15. The apparatus according to claim 10, wherein the determined rotor deflection parameter comprises a concavity of the rotor.

16. The apparatus according to claim 10, wherein the determined rotor deflection parameter comprises a maximum deflection of the rotor from a rotation axis.

17. The apparatus according to claim 10, wherein the optic fiber is coupled to a data acquisition device using a free rotating joint.

18. The apparatus according to claim 10, wherein a three dimensional shape of the rotor is determined based on the strain information, and wherein the rotor defection parameter is determined from the three dimensional shape of the rotor.
